(19) United States
(12) Patent Application Publication
(10) Pub. No.: US 2008/0257315 A1
(43) Pub. Date: Oct. 23, 2008

(54) FUEL VAPORIZER, METHOD OF INSTALLING THE VAPORIZER, AND FUEL VAPORIZER SYSTEM AND METHOD OF CONTROLLING THE SYSTEM

(76) Inventor: Charles W. Thomas, Ashland, KY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/757,444

(22) Filed: Jun. 4, 2007

Related U.S. Application Data
(60) Provisional application No. 60/907,843, filed on Apr. 19, 2007.

(51) Int. Cl. F02M 31/18

(52) U.S. Cl. 123/548; 123/557; 165/154; 261/144; 29/890.036; 700/274

(57) ABSTRACT

A fuel vaporizer includes an inner tube including a liquid fuel inlet for receiving liquid fuel and plural openings, a fuel vaporizing chamber formed on the inner tube, and comprising a fuel vapor outlet, an outer housing formed on the fuel vaporizing chamber, such that a reservoir is formed between the fuel vaporizing chamber and the outer housing, and a heating fluid inlet and heating fluid outlet which are connected to the outer housing.

### BACKGROUND OF THE INVENTION

1. Field of the Invention

The present invention relates to a fuel vaporizer and a fuel vaporizer system, and more particularly, to a fuel vaporizer which includes an inner tube with plural openings, and a fuel vaporizing chamber formed on the inner tube.

2. Description of the Related Art

Typically, an internal combustion engine may use only a portion of the fuel to drive the engine, and the remainder is lost to emissions. Thus, these engines could be more fuel efficient.

It has been suggested that fuel efficiency could be improved by vaporizing the fuel before introducing the fuel into the combustion chamber of the engine. Several attempts have been made to provide an efficient fuel vaporizer.

However, such conventional fuel vaporizers are cumbersome and/or ineffective.

### SUMMARY OF THE INVENTION

In view of the foregoing and other problems, disadvantages, and drawbacks of the related art, a purpose of the exemplary aspects of the present invention is to provide an efficient and effective fuel vaporizer and method of installing the fuel vaporizer, and fuel vaporizer system and method of controlling the fuel vaporizer system.

In a first exemplary aspect, a fuel vaporizer includes an inner tube including a liquid fuel inlet for receiving liquid fuel and plural openings, a fuel vaporizing chamber formed on the inner tube, and including a fuel vapor outlet (e.g., through which fuel vapor exits), an outer housing formed on the fuel vaporizing chamber, such that a reservoir is formed between the fuel vaporizing chamber and the outer housing, and a heating fluid inlet and heating fluid outlet which are connected to the outer housing.

A second exemplary aspect of the present invention is directed to a fuel vaporizer system including a fuel vaporizer connected to a fuel line. The fuel vaporizer includes an inner tube including a liquid fuel inlet for receiving liquid fuel and plural openings, a fuel vaporizing chamber formed on the inner tube, and including a fuel vapor outlet (e.g., through which fuel vapor exits), an outer housing formed on the fuel vaporizing chamber, such that a reservoir is formed between the fuel vaporizing chamber and the outer housing, and a heating fluid inlet and heating fluid outlet which are connected to the outer housing. The system further includes a first valve for controlling a flow rate of heating fluid in the fuel vaporizer, and a microcontroller operatively coupled to the first valve for controlling the first valve for controlling the flow rate of the heating fluid in the fuel vaporizer.

Another exemplary aspect of the present invention is directed to a method of installing a fuel vaporizer in an engine, including providing a fuel vaporizer which includes an inner tube including a liquid fuel inlet for receiving liquid fuel and plural openings, a fuel vaporizing chamber formed on the inner tube, and including a fuel vapor outlet (e.g., through which fuel vapor exits), an outer housing formed on the fuel vaporizing chamber, such that a reservoir is formed between the fuel vaporizing chamber and the outer housing, and a heating fluid inlet and heating fluid outlet which are connected to the outer housing, cutting an engine coolant line of the engine and connecting cut ends of the engine coolant line to the heating fluid inlet and outlet, and cutting a fuel line of the engine and connecting cut ends of the fuel line to the liquid fuel inlet and the fuel vapor outlet.

Another exemplary aspect of the present invention is directed to a method of controlling a fuel vaporizer system in an engine. The method includes detecting an operating variable for the engine, generating an operating variable signal based on the detected operating variable, using a microcontroller to generate a control signal based on the operating variable signal, and controlling a valve of a fuel vaporizer system of the engine based on the control signal.

Another exemplary aspect of the present invention is directed to a programmable storage medium tangibly embodying a program of machine-readable instructions executable by a digital processing apparatus to perform a method of controlling a fuel vaporizer system in an engine, according to an exemplary aspect of the present invention.

With its unique and novel features, the present invention provides an efficient and effective fuel vaporizer and method of installing the fuel vaporizer, and fuel vaporizer system and method of controlling the fuel vaporizer system.

### BRIEF DESCRIPTION OF THE DRAWINGS

The foregoing and other objects, aspects and advantages will be better understood from the following detailed description of preferred embodiments of the invention with reference to the drawings, in which:

FIG. 1 illustrates a fuel vaporizer 100, according to an exemplary aspect of the present invention;

FIG. 2A-2B illustrates another aspect of the fuel vaporizer 100, according to another exemplary aspect of the present invention;

FIG. 2D illustrates a surface of the inner tube 110 in the fuel vaporizer 100, according to another exemplary aspect of the present invention;

FIG. 2E illustrates an axial view of the inner tube 110 of the fuel vaporizer 100, according to another exemplary aspect of the present invention;

FIG. 3 illustrates a fuel vaporizer 300, according to still another exemplary aspect of the present invention;

FIG. 4A illustrates a fuel vaporizer system 400, according to another exemplary aspect of the present invention;

FIG. 4B illustrates a Bayesion Belief Network 490 which may be used by the microcontroller 430, according to another exemplary aspect of the present invention;

FIG. 5 illustrates a method 500 of installing a fuel vaporizer in an engine, according to an exemplary aspect of the present invention.

FIG. 6 illustrates a method 600 of controlling a fuel vaporizer system in an engine, according to an exemplary aspect of the present invention;

FIG. 7 illustrates a typical hardware configuration 700 which may be used for implementing the present invention; and

FIG. 8 illustrates a signal bearing medium 800 which may be used to store instructions for performing the inventive method according to the present invention.

### DETAILED DESCRIPTION OF THE PREFERRED EMBODIMENTS OF THE INVENTION

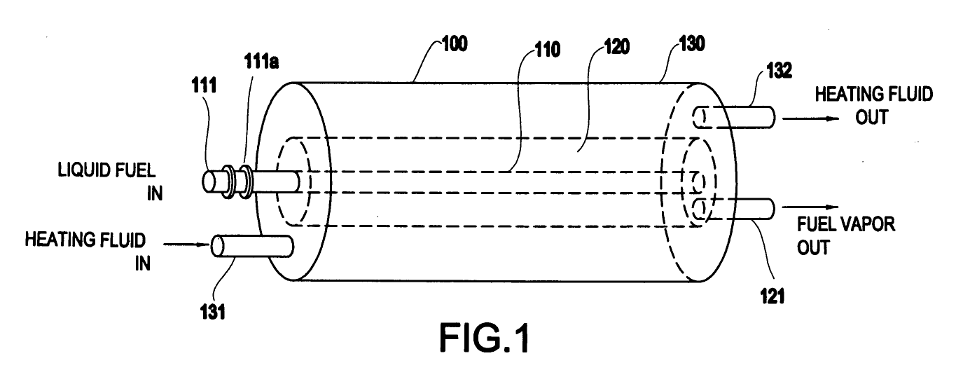

Referring now to the drawings, FIGS. 1-8 illustrate some exemplary aspects the present invention.

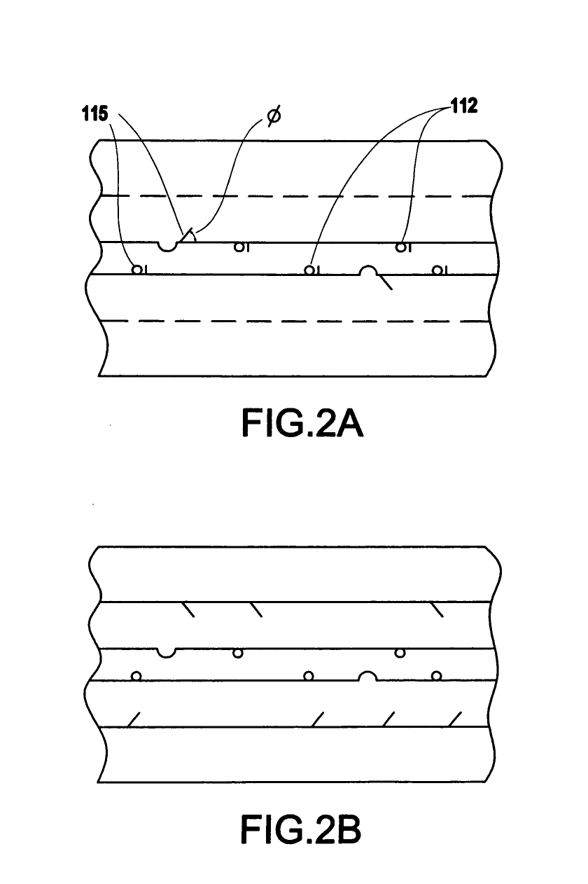

As illustrated, for example, in FIGS. 1-2B, a fuel vaporizer 100 may include an inner tube 110 (e.g., a cylindrical inner tube) including a liquid fuel inlet 111 for receiving liquid fuel and plural openings 112, a fuel vaporizing chamber 120 formed on the inner tube 110, and including a fuel vapor outlet 121 (e.g., through which fuel vapor exits), an outer housing 130 formed on the fuel vaporizing chamber 120, such that a reservoir is formed between the fuel vaporizing chamber 120 and the outer housing 130, and a heating fluid inlet 131 and heating fluid outlet 132 which are connected to the outer housing 130.

For example, the liquid fuel (e.g., gasoline, gasoline/ethanol mix, ethanol, diesel, biodiesel, etc.) may exit the inner tube 110 and enter the fuel vaporizing chamber 120 through the plural openings, the liquid fuel may be vaporized to fuel vapor in the fuel vaporizing chamber 120, and the fuel vapor may exit the fuel vaporizing chamber 120 through the fuel vapor outlet 121.

The liquid fuel inlet 111 and fuel vapor outlet 121 may have an outer diameter which is approximately the same as an inner diameter of a vehicle fuel line. The fuel line may fit snugly around the inlet 111 and outlet 121. In addition (as illustrated on in the inlet 111), the inlet 111 and/or outlet 121 may include a taper design (e.g., having a decreasing diameter in a direction toward an end of the inlet/outlet) to ease insertion into the fuel line, and one or more ridges 111a circumferentially formed around the surface of the inlet 111 and/or outlet 121 to help ensure that the fuel line is securely fit onto the inlet 111 and/or outlet 121. In addition, after the inlet 111 and outlet 121 are inserted into the fuel line, a hose clamp may be formed around the outside of the fuel line to securely fix the fuel line to the inlet 111 and outlet 121.

Similarly, the heating fluid inlet 131 and/or outlet 132 may have an outer diameter which is approximately the same as an inner diameter of a vehicle engine coolant line. The engine coolant line may fit snugly around the inlet 131 and outlet 132. In addition (as illustrated on in the inlet 111), the inlet 131 and/or outlet 132 may include a taper design (e.g., having a decreasing diameter in a direction toward an end of the inlet/outlet) to ease insertion into the engine coolant line, and one or more ridges 111a circumferentially formed around the surface of the inlet 131 and/or outlet 132 to help ensure that the engine coolant line is securely fit onto the inlet 131 and/or outlet 132. In addition, after the inlet 131 and outlet 132 are inserted into the engine coolant line, a hose clamp may be formed around the outside of the engine coolant line to securely fix the line to the inlet 131 and outlet 132.

The fuel vaporizer 100 may be formed, for example, of steel, or of some synthetic material (e.g., synthetic polymer or ceramic) which may withstand the operating conditions of the fuel vaporizer. For example, the fuel vaporizing chamber 120 may be under an internal pressure and the device may also operate in a temperature range from about 190° F. to about 230° F.

The vaporizer 100 may have a length of ranging from about one inch to about 8 inches, or more preferably in a range from about 2 inches to about 4 inches. The vaporizer 100 may also have an outer diameter (e.g., outer diameter of outer housing 130) in a range from about one inch to about 2 inches to about 4 inches.

Further, the plural openings 112 in the inner tube 110 may include about 2-4 holes per every one inch of length of the vaporizer 100. That is, for example, a vaporizer 100 that is about 4 inches long may include from about 8 to about 16 holes. Further, the openings 112 could be distributed across the length and circumference of the inner tube, as illustrated, for example, in FIGS. 2A-2B.

Further, the diameter of the openings 112 should be sufficient (e.g., sufficiently small) to cause sufficient pressure for spraying the liquid fuel in a direction of the outer wall of the fuel vaporizing chamber 120. For example, the diameter may be in a range from about 0.01 inches to about 0.03 inches.

Further, as illustrated in FIGS. 2A-2E, plural deflectors 115 may be formed in the fuel vaporizing chamber 120, for dispersing the liquid fuel which exits the plural openings 112. The plural deflectors 115 may be formed adjacent to the plural openings 112, respectively. Further, the plural deflectors 115 may be formed an outer surface of the inner tube 110 (e.g., see FIG. 2A), and/or the deflectors 115 may be formed on an outer surface of the fuel vaporizing chamber 120.

Further, the plural deflectors 115 may extend from the outer surface of the inner tube 110 in a radial direction and have a length in a range from 0.10 inches to 1.0 inches. The deflectors 115 may also be formed at an angle with respect to the outer surface. For example, the angle may be in a range from 30° to 60°.

The openings 112 in the inner tube 110 may have, for example, a circular shape, oval shape, or slit shape. Further, the opening 112 may be formed in the inner tube 110 in a manner which may promote spraying of the liquid fuel onto the outer surface of vaporizing chamber 120, and/or to promote a swirling motion of the liquid fuel around the outer surface of the vaporizing chamber 120 which may improve the heat transfer efficiency of the vaporizer 100. For example, as illustrated in FIG. 2C which illustrates cross sectional view of the inner tube 110 and vaporizing chamber 120, the openings 112 may be formed by drilling a hole in the inner tube at an angle which may cause the liquid fuel to exit the opening 112 in a direction of the outer wall of the vaporizing chamber 120 at an angle. In addition, baffles may also be welded to the outer wall of the vaporizing chamber 120 in order to improve the heat transfer efficiency of the vaporizer 100.

In addition, the deflectors 115 may have a shape, size and/or placement for promoting heat transfer in the vaporizer 100. For example, as illustrated in FIG. 2D which illustrates a surface of the inner tube 110, the deflector 115 may have curved shape and may be formed on the wall of the inner tube 110 in a circumferential direction and/or in a longitudinal direction from an associated opening 112.

In addition as illustrated in FIG. 2E which illustrates an axial view of the inner tube 110, the deflector 115 may have a flat shape and may be formed in a circumferential direction from the opening 112, and may be formed on an angle Φ in a circumferential direction. Such angle may be in a range, for example, from 30° to 60° from the surface of the inner tube 110.

The fuel vaporizer 100 may also include a heat insulating layer formed on the outer housing 130. The heat insulating layer may include, for example, a fiberglass layer or other heat insulating material.

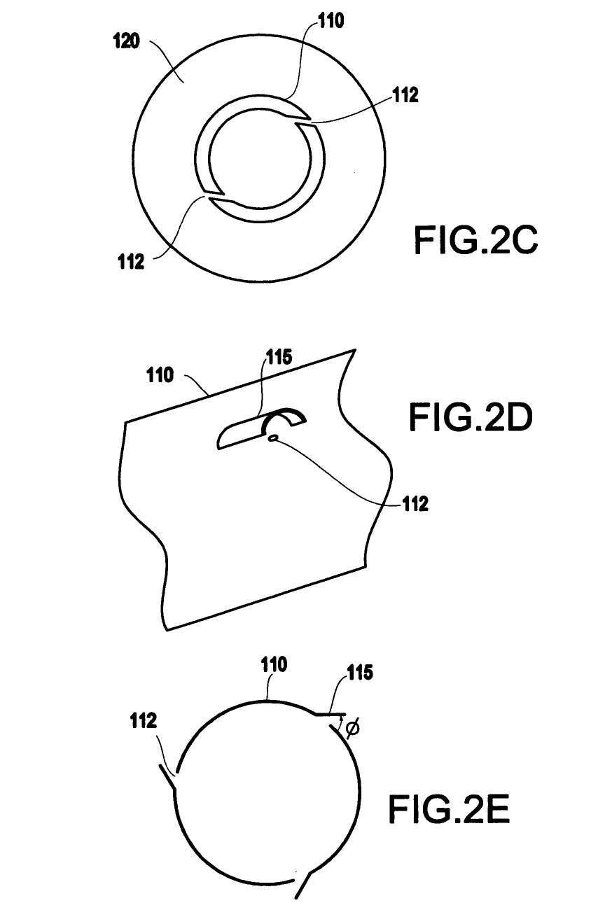

FIG. 3 illustrates a fuel vaporizer 300 according to another exemplary aspect of the present invention. The fuel vaporizer 300 may be similar in many respects to the vaporizer 100. However, as illustrated in FIG. 3 which illustrates an axial view of the vaporizer 300, the inlet and outlet 131, 132 may be formed not on the end wall but on the outer cylindrical surface of the outer housing 130. In this case, as illustrated in FIG. 3B, the inlet 131 and 132 may be formed 180° from each other. The heating fluid inlet 131 and outlet 132 may also be formed on a same end wall 135 of the outer housing 130.

In addition, the vaporizer 300 may include a mounting structure (e.g., bracket, clip) 350 that may be used to mount or secure the vaporizer to another structure or device in a vehicle. The mounting structure 350 may include an opening 351 through which a fixing member (e.g., screw, tie) may be inserted to facilitating mounting. The mounting structure 350 may be fixed to the outer housing of the vaporizer, for example, by welding, adhesive, etc.

Further, the vaporizer 300 may also include a valve 310 for controlling a flow rate of heating fluid in the fuel vaporizer 300. For example, the valve 310 could be formed on the heating fluid inlet 131 or on the outlet 132.

The vaporizer 300 may also include a valve 320 for controlling a flow rate of fuel in the fuel vaporizer 300. For example, the valve 320 may be formed on the fuel inlet 111, or on the fuel vapor outlet 121.

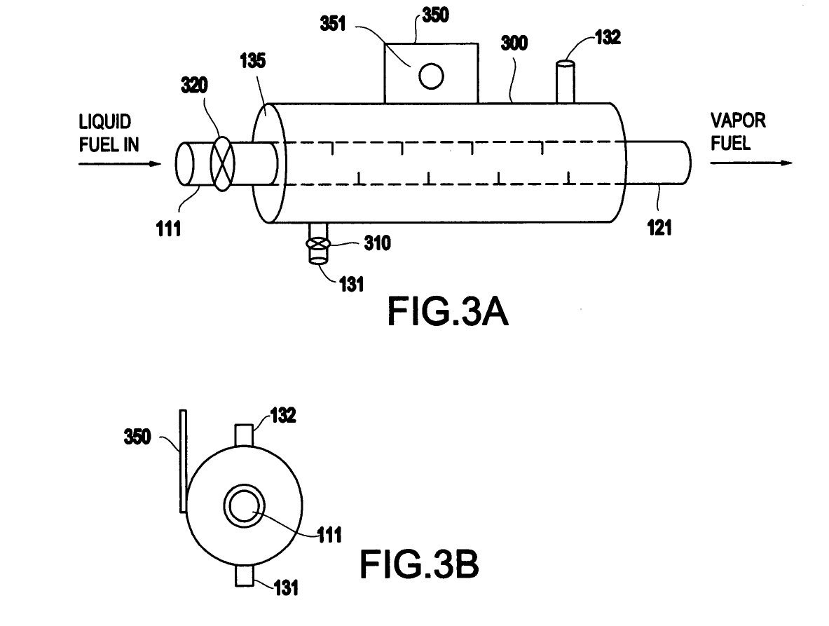

As illustrated in FIG. 4A, another aspect of the present invention is directed to a fuel vaporizer system 400 including a fuel vaporizer connected to a fuel line of a vehicle's engine 490. The fuel vaporizer system 400 may include, for example, a fuel vaporizer 410 (e.g., such as the vaporizer 100 illustrated in FIGS. 1-2B). The system 400 may also include a first valve 420 for controlling a flow rate of heating fluid in the fuel vaporizer 410, and a microcontroller 430 operatively coupled to the first valve 420 for controlling the first valve 420 for controlling the flow rate of the heating fluid in the fuel vaporizer 410.

As illustrated in FIG. 4A, the first valve 420 may be formed proximate to one of the heating fluid inlet and the heating fluid outlet of the fuel vaporizer 410. Further, the system 400 may also include a sensor 450 for detecting an ambient temperature, and the sensor 450 may transmit a signal to the microcontroller 430 which controls the first valve 420 based on the signal from the sensor 450.

The system 400 may also include a second valve 425 for controlling a flow rate of fuel in the fuel vaporizer 410. The microcontroller 430 may be operatively coupled to the second valve 425 for controlling the second valve 425 for controlling the flow rate of the fuel in the fuel vaporizer 410. The second valve 425 may be formed on one of the liquid fuel inlet and the fuel vapor outlet.

The microcontroller 430 may also be operatively coupled to the fuel pump 445 which may be formed on the fuel tank 440 for controlling a flow rate of fuel in the fuel vaporizer 400.

The system 400 may also include a pressure sensor 460 connected to the fuel outlet, for sensing a pressure of the fuel vapor. The pressure sensor 460 may transmit a signal to the microcontroller 430 which controls the second valve based on the signal from the pressure sensor 460.

The system 400 may also include a combustion sensor 475 (e.g., which may be formed in the engine exhaust 470) for detecting a fuel combustion efficiency. The combustion sensor 475 may transmit a signal to the microcontroller 430 which controls at least one of the first and second valves based on the signal from the combustion sensor 475.

The microcontroller 430 may include for example, the engine control unit (ECU) for the engine in which the fuel vaporizer system 400 is utilized. The ECU be used for example, to determine the quantity of fuel, ignition timing and other parameters by monitoring the engine through sensors. These can include, a manifold absolute pressure (MAP) sensor, throttle position sensor, air temperature sensor, oxygen sensor, etc.

For an engine with fuel injection, the microcontroller 430 may also determine the quantity of fuel to inject based on a number of parameters. If the throttle pedal is pressed further down, the throttle body may be further opened to allow more air to be pulled into the engine 490. The microcontroller 430 may also inject more fuel according to how much air is passing into the engine 490. If the engine 490 has not warmed up yet, more fuel may be injected which may cause the engine 490 to run slightly ‘rich’ until the engine 490 warms up.

The engine 490 (e.g., a spark ignition engine) may require a spark to initiate combustion in the combustion chamber. The microcontroller 430 can also adjust the exact timing of the spark (called ignition timing) to provide better power and economy. If the microcontroller 430 detects knock, a condition which is potentially destructive to engines, and “judges” it to be the result of the ignition timing being too early in the compression stroke, it may delay the timing of the spark to prevent the knock. The microcontroller 430 may also control the vehicle's transmission (e.g., an automatic transmission) by simply downshifting the transmission were this the cause of knock/ping.

The engine 490 may also have Variable Valve Timing, in which case the microcontroller 430 may control the time in the engine cycle at which the valves open. The valves may be opened later at higher speed than at lower speed. This can optimize the flow of air into the cylinder, increasing power and economy.

The microcontroller 430 may also be a programmable microcontroller (e.g., programmable ECU) which can be reprogrammed by the user. The microcontroller 430 may also process the inputs from the engine sensors in real time. The microcontroller 430 may include hardware and software (e.g., computer readable instructions stored on a programmable storage medium). The hardware may include, for example, electronic components on a printed circuit board (PCB). The main component on this circuit board is a microcontroller chip (CPU). The software may be stored in the microcontroller or other chips on the PCB, (e.g., EPROMs or flash memory) so the CPU can be re-programmed by uploading updated code.

It should be noted that the microcontroller 430 may control the vaporizer (e.g., by controlling valves 420, 425 or fuel pump 425 based on any data that is typically received and/or stored in a microcontroller. For example, the microcontroller 430 may adjust the valves 420, 425 based on a signal received in the microcontroller 430 from the manifold absolute pressure (MAP) sensor, throttle position sensor, air temperature sensor, oxygen sensor, etc.

Likewise, any of the devices which are typically controlled by a microcontroller may be controlled based, for example, on a setting of the valves 420, 425 or on a pressure signal from the pressure sensor 460. For example, the microcontroller 430 could also adjust the ignition timing in the engine depending on the setting of the valves 420, 425.

In addition, if the sensor 460 detects a pressure that is above an upper threshold value and/or below a lower threshold value stored in the microcontroller 430, the microcontroller 430 may reduce the opening and/or completely close off the valve 425 in order to reduce and/or stop the flow of fuel into the vaporizer 410 (e.g., a feedback control loop). Thus, for example, if the fuel line becomes disconnected from the vapor fuel outlet of the vaporizer 410, the sensor 460 may detect a pressure that is lower than the lower threshold value and shut the valve 425 to stop the fuel flow.

A purpose of the vaporizer 410 may be to vaporize 100 percent of the liquid fuel input to the vaporizer 410 (e.g., to provide a 100% vaporization rate). The microcontroller 430 may be provided with an adaptive learning function which may help to improve the effectiveness of the vaporizer 410 based on a history of data received by and/or stored by the microcontroller 430. For example, the microcontroller 430 may use history data from signals from a manifold absolute pressure (MAP) sensor, throttle position sensor, air temperature sensor, oxygen sensor to “fine tune” the vaporizer over time.

To provide this adaptive learning function, the microcontroller may utilize, for example a Bayesian network which is sometimes called a “belief network”. Other machine learning techniques, such as decision trees and neural networks can also be used. However, Bayesian networks offer several advantages in handling missing data (features), learning and explaining causal relationship between various attributes including features, incorporating expert knowledge, and avoiding over-fitting of data.

A Bayesian network is an acyclic-directed graph (without any loops) in which nodes represent variables and arcs represent cause-effect relationship (e.g., an arc from node a to b indicates that variable a is a direct cause for variable b). Each node is associated with a conditional probability distribution P(xᵢ|IIᵢ), where IIᵢ denotes the parents of the node variable xᵢ. The strength of the causal relationship is encoded in this distribution. A beneficial property of Bayesian networks is that the joint probability distribution encoded in the network can be computed by the product of all the conditional probability distributions stored in its nodes. If a node has no parents, then the conditional variable is empty.

For example, FIG. 4B illustrates a simple Bayesian network with three variables, a, b and c. Variable a is the parent of both b and c, which says that both b and c depend on a, but b and c are conditionally independent given a. The joint probability P(a, b, c)=P(a)P(b|a)P(c|a).

Once a Bayesian network is built, one can issue a number of queries. For example, given a set of observations (e.g., often-called “evidence”) on the states of some variables in the network, one can infer the most probable state(s) for any unobserved variable(s). This applies to the problem of inferring a vaporization rate in the vaporizer 410. It is noted that it is unnecessary to have all the features in order to infer the vaporization rate. This is particularly desirable because some features may not be reliably obtained under certain circumstances.

The structure and parameters of a Bayesian network can be learned from experimental data using the algorithms described in D. Heckerman, “A Tutorial on Learning with Bayesian Network”, MSR-TR-95-06, and E. Castillo et al., “Expert Systems and Probabilistic Network Models”, Springer, 1998. Bayesian networks have been used for performing collaborative filtering (e.g., see U.S. Pat. No. 5,704,017, incorporated herein by reference), and probabilistic subject modeling based on a subject's background, actions, and queries (e.g., see E. Horvitz et al., “The Lumiere Project: Bayesian User Modeling for Inferring the Goals and Needs of Software Users”, Proc. of the 14th Conference on Uncertainty in Artificial Intelligence. Madison, Wis. July, 1998).

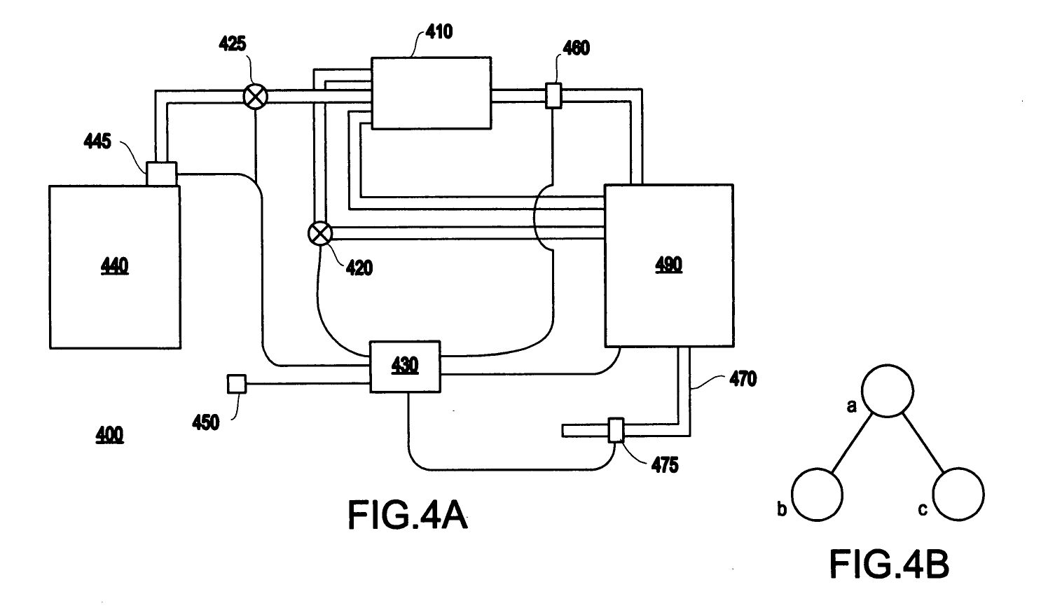

FIG. 5 illustrates a method 500 of installing a fuel vaporizer in an engine, according to an exemplary aspect of the present invention. The method includes providing (510) a fuel vaporizer which includes an inner tube including a liquid fuel inlet for receiving liquid fuel and plural openings, a fuel vaporizing chamber formed on the inner tube, and comprising a fuel vapor outlet (e.g., through which fuel vapor exits), an outer housing formed on the fuel vaporizing chamber, such that a reservoir is formed between the fuel vaporizing chamber and the outer housing, and a heating fluid inlet and heating fluid outlet which are connected to the outer housing, cutting (520) an engine coolant line of the engine and connecting cut ends of the engine coolant line to the heating fluid inlet and outlet, and cutting (530) a fuel line of the engine and connecting cut ends of the fuel line to the liquid fuel inlet and the fuel vapor outlet.

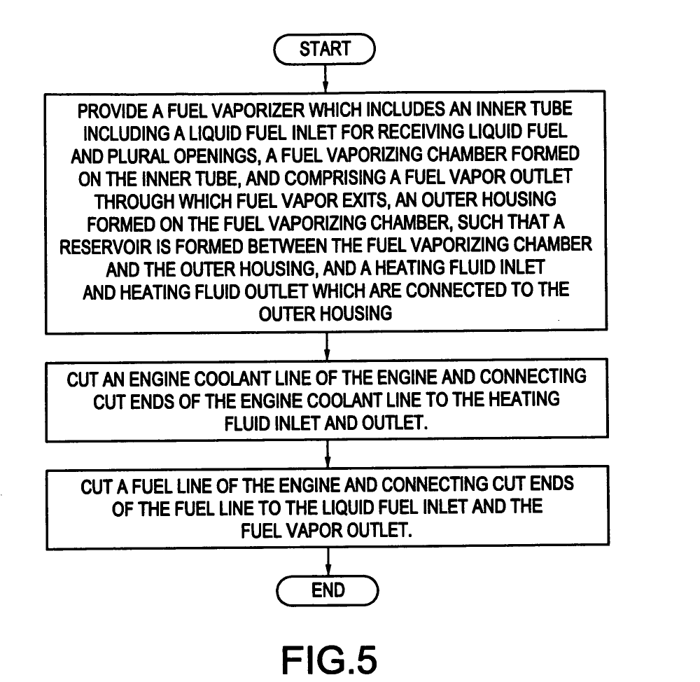

FIG. 6 illustrates a method 600 of controlling a fuel vaporizer system in an engine. The method 600 includes detecting an operating variable for the engine, generating an operating variable signal based on the detected operating variable, using a microcontroller to generate a control signal based on the operating variable signal, and controlling a valve of a fuel vaporizer system of the engine based on the control signal.

In summary, an exemplary aspect of the present invention is directed to a fuel vaporizer (e.g., fuel vaporizer 100) that can be easily installed in a fuel line, such as the fuel line of a vehicle (e.g., an automobile). Liquid fuel from the fuel tank of a vehicle may enter the vaporizer 100, where the liquid fuel is heated and exits the vaporizer 100 as a vapor.

The fuel vaporizer 100 may be in the form, for example, of a heat exchanger (e.g., shell and tube type) having an inner tube for transporting the fuel and a shell for containing the heat exchange medium. The heat exchange medium may include, for example, engine coolant (e.g., water), which may enter the fuel vaporizer in a range from about 190° F. to about 230° F.) from the engine coolant line. For example, an outer housing of the fuel vaporizer 100 (e.g., an outer shell) shell could have an inlet connected to a first part of the heater line, and an outlet connected to another part of the engine coolant line.

Further, no additional pumps (e.g., fuel pumps or engine coolant pumps) may be needed to operate the fuel vaporizer 100. That is, the heating fluid (e.g., engine coolant) may be pumped through the fuel vaporizer 100 by the vehicle's water pump, and fuel may be pumped through the vaporizer 100 by the vehicle's fuel pump.

Further, the inner walls of the inner tube may include deflectors (e.g., deflectors) for improving the exchange of heat from the heating fluid (e.g., engine coolant) to the fuel. A layer of insulation may also be applied around the outer surface of the vaporizer 100 (e.g., around the outer housing), to improve the efficiency of the heat transfer from the heating fluid (e.g., engine coolant) to the fuel.

The inlet on the shell for inputting the heating fluid (e.g., water or other engine coolant) to the vaporizer may include a valve which may be electronically controlled by the vehicle's microcontroller 430 (electronic control unit (ECU)). For example, on a cold day, a fuel vaporizer system including the microcontroller 430 may include a sensor for detecting the ambient temperature, in which case the microcontroller 430 may cause the valve (e.g., heating fluid valve) to open wider to increase the flow rate of the heating fluid into the vaporizer to ensure complete vaporization of the fuel. The microcontroller may also use feedback control for controlling the valve (e.g., heating fluid valve) based on the performance of the engine (e.g., fuel efficiency) or other operating variable.

In addition, a fuel vaporizer system may include (e.g., proximate to a fuel outlet of the vaporizer) a pressure sensor for detecting a vapor pressure inside the fuel vaporizing chamber and/or inside the fuel line. The vapor pressure data may be sent to the microcontroller 430 which may use the vapor pressure data to control the water valve (e.g., feedback control), or the fuel valve or fuel pump.

Further, the microcontroller 430 may use the fuel efficiency data or vapor pressure data to control the fuel pump (e.g., increase/decrease fuel flow rate) and/or water pump (e.g., increase/decrease water flow rate).

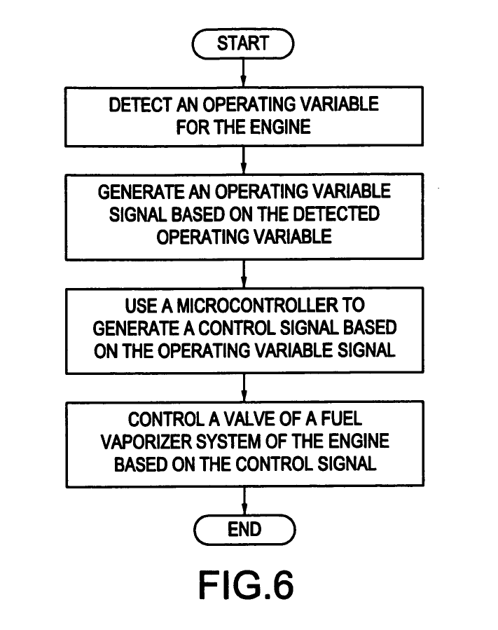

Referring again to the drawings, FIG. 7 illustrates a typical hardware configuration which may be used for implementing the inventive system and method for scaling a signal. The configuration has preferably at least one processor or central processing unit (CPU) 711. The CPUs 711 are interconnected via a system bus 712 to a random access memory (RAM) 714, read-only memory (ROM) 716, input/output (I/O) adapter 718 (for connecting peripheral devices such as disk units 721 and tape drives 740 to the bus 712), user interface adapter 722 (for connecting a keyboard 724, mouse 726, speaker 728, microphone 732, and/or other user interface device to the bus 712), a communication adapter 734 for connecting an information handling system to a data processing network, the Internet, and Intranet, a personal area network (PAN), etc., and a display adapter 736 for connecting the bus 712 to a display device 738 and/or printer 739. Further, an automated reader/scanner 741 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing media tangibly embodying a program of machine-readable instructions executable by a digital data processor to perform the above method.

Such a method may be implemented, for example, by operating the CPU 711 to execute a sequence of machine-readable instructions. These instructions may reside in various types of signal bearing media.

Thus, this aspect of the present invention is directed to a programmed product, comprising signal-bearing media tangibly embodying a program of machine-readable instructions executable by a digital data processor incorporating the CPU 711 and hardware above, to perform the method of the invention.

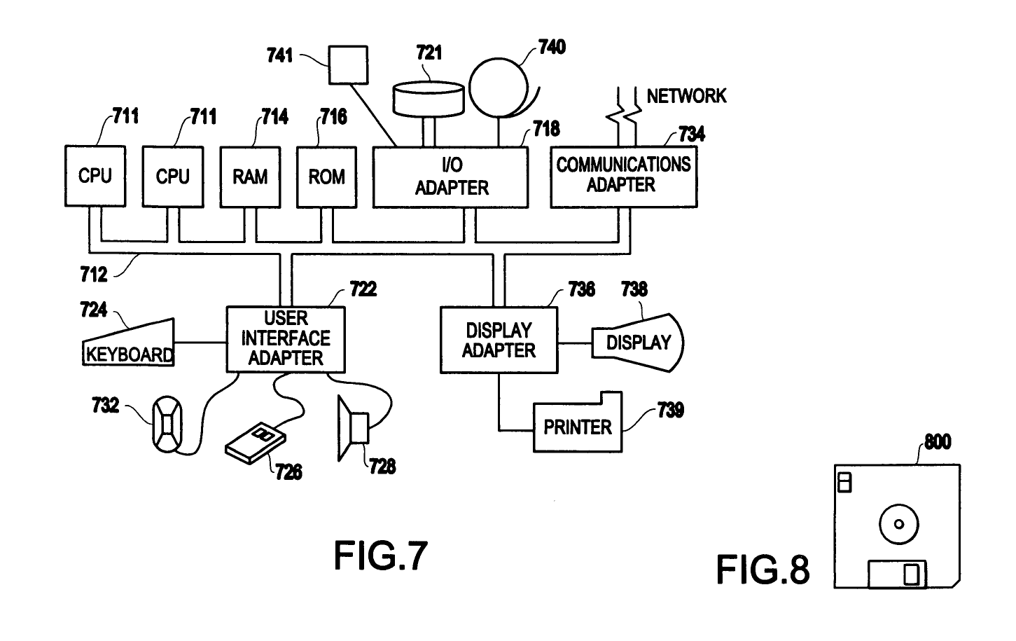

This signal-bearing media may include, for example, a RAM contained within the CPU 711, as represented by the fast-access storage for example. Alternatively, the instructions may be contained in another signal-bearing media, such as a magnetic data storage diskette 800 (FIG. 8), directly or indirectly accessible by the CPU 711.

Whether contained in the computer server/CPU 711, or elsewhere, the instructions may be stored on a variety of machine-readable data storage media, such as DASD storage (e.g, a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, complied from a language such as “C,” etc.

While the invention has been described in terms of preferred embodiments, those skilled in the art will recognize that the invention can be practiced with modification within the spirit and scope of the appended claims.

With its unique and novel features, the present invention provides an efficient and effective fuel vaporizer and method of installing the fuel vaporizer, and fuel vaporizer system and method of controlling the fuel vaporizer system.

What we claim is:

1. A fuel vaporizer comprising:
an inner tube including a liquid fuel inlet for receiving liquid fuel and plural openings;
a fuel vaporizing chamber formed on said inner tube, and comprising a fuel vapor outlet through;
an outer housing formed on said fuel vaporizing chamber, such that a reservoir is formed between said fuel vaporizing chamber and said outer housing; and
a heating fluid inlet and heating fluid outlet which are connected to said outer housing.

2. The fuel vaporizer of claim 1, wherein said liquid fuel exits said inner tube and enters said fuel vaporizing chamber through said plural openings, said liquid fuel is vaporized to fuel vapor in said fuel vaporizing chamber, and said fuel vapor exits said fuel vaporizing chamber through said fuel vapor outlet.

3. The fuel vaporizer of claim 2, further comprising:
plural deflectors formed in said fuel vaporizing chamber, for dispersing said liquid fuel which exits said plural openings.

4. The fuel vaporizer of claim 3, wherein said plural deflectors are formed adjacent to said plural openings, respectively.

5. The fuel vaporizer of claim 3, wherein said plural deflectors are formed on one of an outer surface of said inner tube, and outer surface of said fuel vaporizing chamber.

6. The fuel vaporizer of claim 3, wherein said plural deflectors extend from said outer surface of said inner tube in a radial direction and have a length in a range from 0.25 inches to 1.0 inches, and are formed at an angle with respect to said outer surface.

7. The fuel vaporizer of claim 6, wherein said angle is in a range from 30° to 60°.

8. The fuel vaporizer of claim 1, further comprising:
a heat insulating layer formed on said outer housing.

9. The fuel vaporizer of claim 1, further comprising:
a valve formed on said heating fluid inlet for controlling a flow rate of heating fluid in said fuel vaporizer.

10. The fuel vaporizer of claim 1, further comprising:
a valve formed on said fuel inlet for controlling a flow rate of fuel in said fuel vaporizer.

11. A fuel vaporizer system comprising:
a fuel vaporizer connected to a fuel line, comprising
an inner tube including a liquid fuel inlet for receiving liquid fuel and plural openings;
a fuel vaporizing chamber formed on said inner tube, and comprising a fuel vapor outlet;
an outer housing formed on said fuel vaporizing chamber, such that a reservoir is formed between said fuel vaporizing chamber and said outer housing; and
a heating fluid inlet and heating fluid outlet which are connected to said outer housing
a first valve for controlling a flow rate of heating fluid in said fuel vaporizer; and
a microcontroller operatively coupled to said first valve for controlling said first valve for controlling said flow rate of said heating fluid in said fuel vaporizer.

12. The fuel vaporizer system of claim 11, wherein said first valve is formed on one of said heating fluid inlet and said heating fluid outlet.

13. The fuel vaporizer system of claim 11, further comprising:
a sensor for detecting an ambient temperature,
wherein said sensor transmits a signal to said microcontroller which controls said first valve based on said signal from said sensor.

14. The fuel vaporizer system of claim 11, further comprising:
a second valve for controlling a flow rate of fuel in said fuel vaporizer,
wherein said microcontroller is operatively coupled to said second valve for controlling said second valve for controlling said flow rate of said fuel in said fuel vaporizer.

15. The fuel vaporizer system of claim 14, wherein said second valve is formed on one of said liquid fuel inlet and said fuel vapor outlet.

16. The fuel vaporizer system of claim 14, further comprising:
a pressure sensor connected to said fuel outlet, for sensing a pressure of said fuel vapor,
wherein said pressure sensor transmits a signal to said microcontroller which controls said second valve based on said signal from said pressure sensor.

17. The fuel vaporizer system of claim 11, further comprising:
a combustion sensor for detecting a fuel combustion efficiency,
wherein said combustion sensor transmits a signal to said microcontroller which controls at least one of said first and second valves based on said signal from said combustion sensor.

18. A method of installing a fuel vaporizer in a vehicle having an engine, comprising:
providing a fuel vaporizer comprising an inner tube including a liquid fuel inlet for receiving liquid fuel and plural openings, a fuel vaporizing chamber formed on said inner tube, and comprising a fuel vapor outlet, an outer housing formed on said fuel vaporizing chamber, such that a reservoir is formed between said fuel vaporizing chamber and said outer housing, and a heating fluid inlet and heating fluid outlet which are connected to said outer housing;
cutting an engine coolant line of said engine and connecting cut ends of said engine coolant line to said heating fluid inlet and outlet; and
cutting a fuel line of said engine and connecting cut ends of said fuel line to said liquid fuel inlet and said fuel vapor outlet.

19. A method of controlling a fuel vaporizer system in an engine, comprising:
detecting an operating variable for said engine;
generating an operating variable signal based on said detected operating variable;
using a microcontroller to generate a control signal based on said operating variable signal; and
controlling a valve of a fuel vaporizer system of said engine based on said control signal.

20. A programmable storage medium tangibly embodying a program of machine-readable instructions executable by a digital processing apparatus to perform a method of controlling a fuel vaporizer system in an engine, said method comprising:
detecting an operating variable for said engine;
generating an operating variable signal based on said detected operating variable;
using a microcontroller to generate a control signal based on said operating variable signal; and
controlling a valve of a fuel vaporizer system of said engine based on said control signal.
